(19) United States
(12) Patent Application Publication
(10) Pub. No.: US 2002/0147613 A1
(43) Pub. Date: Oct. 10, 2002

(54) Methods of marketing summary maps depicting the location of real property and certain traits in the vicinity thereof

(76) Inventors: Robert M. Kennard, Dallas, TX (US); John W. Howard, North Richland Hills, TX (US)

Correspondence Address: Robert C. Klinger, Jackson Walker LLP, Suite 600, 2435 North Central Expressway, Richardson, TX, 75080, US

(21) Appl. No.: 10/119,563

(22) Filed: Apr. 10, 2002

Related U.S. Application Data
(60) Provisional application No. 60/282,815, filed on Apr. 10, 2001.
(60) Provisional application No. 60/294,731, filed on May 31, 2001.

(51) Int. Cl. G06F 17/60; G09G 5/00

(52) U.S. Cl. 705/1; 345/634

(57) ABSTRACT

A computer-implemented method permits the furnishing to a customer of a summary map delineating thereon the site of real property and some trait at the site and in the vicinity of the site. First, the property is located on a georeferenced map showing the trait. The georeferenced map is one of a continuum or matrix of maps, all of which show the trait. Once the site is located, a portion of the georeferenced map with the site generally centrally located thereon is stored and sent to the customer. If the foregoing map portion would otherwise contain some blank areas because the site is near a corner or boundary of the second map, portions of adjoining maps are included in the summary map to preclude this. The summary map ultimately stored and transmitted—whether a portion of the georeferenced map or portions of thegeoreferenced map and maps adjoining it—may be scaled up or down from the scale of the georeferenced map and/or rotated to present North in a selected orientation. Further, the summary map may show property markers, boundary lines, and other indicia., as well as a compass rose and a scale legend. The georeferenced map may be a FEMA flood map, and, where the summary map comprises portions of several adjacent FEMA flood maps, the map panel designation and suffix, panel effective date, community name, county name, etc. of the georeferenced map containing the site may be appended. The summary map transmitted to the customer is often a part of a report covering matters such as acquiring or dropping flood insurance, mortgagor/mortgagee information, a properrty appraisal report, an inspection report, an addendum to a previous flood hazard determination, an agreement/contract to purchase realty, a Floodscape™ report, an insurance quotation/solicitation letter, a Realtor® marketing brochure, and similar matters.

### CROSS REFERENCE TO RELATED APPLICATIONS

The disclosure of the present invention is based on and claims priority from the following commonly assigned provisional application: Serial No. 60/282,815, filed Apr. 10, 2001. Moreover, the disclosure of the present invention relates to and provides a business and marketing platform for the inventions disclosed in the following commonly assigned, co-pending patent applications: Provisional, Serial No. 60/282,041, filed Apr. 6, 2001; provisional, Serial No. 60/294,731, filed May 31, 2001; provisional, Serial No. 60/[Docket 108344.00002], filed Jan. 17, 2002; provisional, Serial No. 60/[Docket 108344.00005], filed Jan. 17, 2002; Ser. No. 09/537,162, filed Mar. 29, 2000 (the “'162 application”); Ser. No. 09/537,849, filed Mar. 29, 2000 (the “'849 application”); and Ser. No. 09/537,161, filed Mar. 29, 2000 (the “'161 application”). All of the foregoing are incorporated by reference hereinto.

### FIELD OF THE INVENTION

The present invention generally relates to methods of marketing summary maps that depict the location of real property as well as certain traits in the vicinity of the property. Specifically, a “summary map” depicts the site of real property and a relatively small portion of a of a larger map that contains the property, and may be accompanied by or bear other related information. More specifically, the present invention relates to business methods for providing to customers summary maps that depict selected real property as well as a trait, such as the flood hazard classification or other characteristic, at the site of, and in the immediate vicinity of, the real property.

### BACKGROUND OF THE INVENTION

The above-noted '849 application discloses and claims a system and method for georeferencing one or more originally non-georeferenced maps that depict a geographic, climatological, ecological or other trait. For example, FEMA flood maps, which depict flood hazard classifications, or maps depicting other traits, inform of the condition of or at the land area covered by the map. Typically, the non-georeferenced maps are paper maps. The system and method contemplate first securing and storing in the system a georeferenced map, such as a vector map, containing the geographic area covered by the non-georeferenced map or maps, and then scanning each paper map to produce a raster image thereof which is also stored in the system. Like the paper map from whence it came, the raster map is non-georeferenced, having only an internal reference system of x,y Cartesian coordinates, each value of which denotes the position of a particular pixel of the raster image.

Each raster image is then generally simultaneously displayed along with the portion of the vector map that contains the area covered by the displayed raster image. Since the vector map is typically a street- or road-map-type of map and the raster image is primarily intended to show a selected trait of or at the land area, e.g., its flood zone classification, the visual impact of each is quite different. Nevertheless, both images will usually contain common artifacts, such as streets, stream beds, railroad tracks, intersections of and among the foregoing, mountain peaks, buildings, shoreline, and the like.

A system user manipulates both images until each display covers approximately the same geographic area. The user than “marks” as points selected artifacts shown in common in both images. For example, if both images depict the intersection of the same two streets, the user marks the intersections by “clicking” a mouse on the intersection in both images to establish a “point-pair.” A stored algorithm calculates a function f which relates the x,y coordinates of the intersection on the raster image to the latitude and longitude of the intersection on the vector image, that is f(x,y) =(lat,lon). The inverse function g establishes the reverse relationship, i.e., g(lat,lon) =(x,y).

A second point-pair is then marked at another common artifact. The algorithm now calculates the functions f and g, thereby providing an initial georeferencing function set by which the two images may be related. As additional point-pairs are marked, the georeferencing functions are refined, until they accurately geographically relate the raster and vector images. The final georeferencing functions are stored. Accordingly, whenever the raster image is displayed, modified, manipulated or otherwise operated on, these operations may be performed pursuant to geographic coordinates of latitude and longitude. The raster image of the non-georeferenced scanned paper map is now georeferenced.

The above-noted '162 application covers a system and method for synchronizing the displayed images of two maps, such as the initially non-georeferenced raster image of the paper map and the georeferenced vector map image. Synchronization is achieved as the algorithm calculates the georeferencing functions. Once the functions are established, manipulation of either image—such as scrolling, panning, zooming in or out, or rotating—causes the same manipulation to be applied to the other image. This synchronization is helpful, inter alia, when the user is attempting to locate and mark common artifacts on the two displayed images.

The above-noted '161 application relates to a system and method for performing assessments of the geographic characteristics of land at and near the location of a piece of real property. Specifically, the '161 application relates to a system and method for performing flood hazard determinations (also known as flood zone certifications).

After FEMA flood maps are georeferenced by the systems and methods of the '849 and '162 applications, similar segments of the vector map each have “attached” thereto all georeferenced flood map images that intersect the segment. As a result, if a property is locatable within one of the segments when its address is given, only the attached flood map images need to be examined to determine which one is usable to determine flood zone classification. Often, there will be only one flood map attached to a vector map segment, in which event, no human intervention is needed to determine the applicable flood map. If two or more flood maps are so attached, human intervention can determine which one is the proper flood map.

In view of the foregoing, the present invention relates to methods of commercializing and marketing the evaluations of a trait of, or at, the land that is at, and near, the site of a selected piece of real property.

### SUMMARY OF THE DISCLOSURE

With the above in view, a first aspect of the present invention contemplates a computer-implemented method by which a service provider can generate for a customer a summary map that accurately depicts a selected trait at the site of selected real property and in the property's vicinity.

According to this first aspect, either the customer is digitally furnished with a first georeferenced map or the customer furnishes the service provider with the address or geographic coordinates of the property of interest. Either may occur because of a request initiated by the customer in response to advertising by the service provider or word of mouth from the provider's satisfied customers. On the other hand, the customer may request a first map in response to the service provider's electronic, or other, contact with the customer.

If a first map is furnished it may bear indicia indicating the purported site of the property and is accompanied by instructions. The instructions inform that if, and only if, the purported site is incorrect, the customer should move or correct the indicia so that the correct site is indicated, and, thereafter, return the first map to the service provider. After the map showing the correct site is received by the service provider, such correct site is located on a georeferenced map that depicts the trait of interest, which, in some embodiments, is a flood zone classification. Locating the correct site on the latter map is achieved directly or indirectly by relating the maps to each other through georeferencing functions.

The trait-depicting map is then marked to indicate the property's site. Last, a selected portion—usually some—of the trait-depictng map is digitally provided to the customer with the correct site of the property shown thereon.

As noted, the customer may also be invited to provide the address or geographic coordinates for the property. When one of these is provided, it is used by the service provider to locate the property on the trait-depicting map.

In another variant, the site is located on two or more second maps, only one of which is usable to accurately depict the trait. In this event, the site is delineated by the service provider on all involved trait-depicting maps, all of which are provided to the customer, who is requested to indicate which of the second maps best depicts both the site of the property and the trait of interest.

In yet another variant, the customer is permitted to download the furnished portion of the trait-depicting map, which may be accompanied by trait-related information or other information, such as a scale legend, a compass rose, advertising, demographic data and the like. The customer may be permitted to download the trait-depicting map portion and the other information to a suitable memory medium or device or to a printer.

In yet another variant of the first aspect, the invention is the portion of the trait-depicting map produced by the foregoing methods and provided to the customer in any manner, whether or not the customer subsequently downloads the map. In a still further variant of this first aspect, the invention is a storage medium or device which contains software capable of operating a general purpose computer to effect any of the variant methods described above.

In a second aspect, the present invention contemplates a method similar to the foregoing, except that the georeferenced map furnished to the customer bears no indication of the purported site of the property. After electronically receiving the map, the customer electronically marks the site of the property thereon and electronically returns it to the service provider. The georeferenced map may also be furnished in digital form stored on a medium or device. In either event, the georeferenced map is accompanied by tools usable by the customer to mark the site of the property on the map and to thereafter transmit it back to the service provider, either electronically or by returning the storage medium of device.

In a variant of this second aspect, the selected portion of the trait-depicting map may be provided to the customer either by direct transmission or by giving the customer a storage medium or device containing the map in digital form. In either of the latter events the trait-depicting map portion may be accompanied by other information, as described earlier, and both the map and the information may be suitable for rendering by the customer in tangible form. In additional variants, (i) the georeferenced map is a digital version of an original paper map, (ii) before the indicia-depicting map portion is provided to the customer, it is assigned a selected scale, which may be indicated on an included scale legend, and is rotated so that North is in a selected orientation.

In a third aspect, the present invention contemplates that the trait-depicting map is a scanned or raster version of a paper map, an example thereof being a FEMA flood hazard map. Where this map is issued by an issuing entity, such as FEMA, EPA, a real estate multiple listing service, or a financial institution, it is typically subject to being changed by the entity. Accordingly, the service provider may, in response to such a change to the map—actually a change to the paper version of the map—georeference the changed second map, preferably, but not necessarily, via the method of the '849 application. The site of the property is then located on the georeferenced changed second map, and this site is delineated thereon. The service provider then provides the changed trait-indicating map to the customer along with other information. The other information may textually inform the customer of the significance of the change to the second map. The foregoing may be marketed on a subscription basis to various customers, who are thereby informed, in specific embodiments, of changes in the flood zone classification of the land on which their property resides and any related changes regarding such matters as flood insurance, pollution control, desirable mortgage changes or average house sale price.

### DETAILED DESCRIPTION

As described earlier, the present invention relates to the inventions of the '849, '161 and '162 applications, which permit non-georeferenced paper maps to be converted to a georeferenced raster format via the use of a companion vector map. In specific embodiments hereof, the paper maps are FEMA flood maps which are used to provide to property owners, lending institutions and others flood hazard classifications or flood zone certificates, with reference to which the acquisition or dropping of flood insurance may be affected or effected.

It is to be understood that while specific embodiments deal with flood hazard classifications, the present invention contemplates methods of furnishing summary maps showing both the site of selected property—either as a “point” on a map or as an area bounded by a polygon—and various characteristics or traits extant at, and in the vicinity of, the property. The characteristics which may be shown on the maps include geographic characteristics, such as flood hazard status, soil type and quality, subsurface water; ecological characteristics, such as air quality, water quality, pollen and fungus concentrations; climatological characteristics, such as amount of rainfall, average temperature, likelihood of tornadoes; demographic characteristics, such as average income or home cost, population density; and any other characteristic that can be shown on a map by coloration, shading (as in the case of FEMA flood maps) or other indicia, along with the location of the selected property.

Turning to certain specific embodiments, over 100,000 FEMA flood maps exist; the majority of them are not georeferenced. The above-noted '849, '161 and '162 applications result in such georeferencing so that originally non-georeferenced raster images of the FEMA maps are mathematically related to a georeferenced map, such as a vector map, which may be a street or road map. As a consequence, any point the coordinates of which can be identified on the vector map may be simultaneously identified on the raster map by the same coordinates, typically latitude and longitude. Accordingly a property address or the (lat,lon) coordinates of the site of real property—where the site is either a point or a polygon—may expeditiously be located on the georeferenced trait-depicting map. If, as in certain embodiments hereof, the raster map is an image of a FEMA flood map, the flood zone status of the property may be just as expeditiously determined.

In the following examples of marketing and commercializing a map delineating both the location of a property and a characteristic or quality extant at and in the vicinity of that property, certain of the steps taken are preferably computer-implemented and are electronically and/or digitally performed.

### EXAMPLE 1

This example relates to a customer obtaining from a service provider a product termed a Floodscape™ flood map. The customer, who has previously learned of the service provider, gains access to the Internet and clicks on an appropriate icon. This gives the customer access to a form at the provider's web site. The form requests that the customer fill in the address of certain property for which, in this example, a flood zone determination is desired. Typically, the address is a post office or mailing address, but may be in the form of latitude/longitude, metes-and-bounds, a legal address or some other location identifier or address for the property.

In the following examples of marketing and commercializing a map delineating both the location of a property and a trait extant at and in the vicinity of that site, certain of the steps taken are preferably computer-implemented and/or are electronically and/or digitally performed.

### EXAMPLE 1

This example relates to a customer obtaining from a service provider a selected product. The customer, who has previously learned of the service provider, gains access to the Internet and clicks on an appropriate link to gain access to a form at the service provider's web site. The form may request that the customer fill in the address of certain property and also indicate the desired service or product, e.g., a FEMA Flood Rate Insurance Map (“FIRM”), a summary of the FIRM, a Floodscape™ or a standard flood hazard determination. Typically, the address is a street address, a mailing address or a post office address, but may be in the form of latitude/longitude, metes-and-bounds, a legal description or some other location identifier or address for the property.

In response to electronically submitting the completed form, a georeferenced street map, such as that available via Mapquest, is displayed. On the map, a star or other icon marks the purported site of the property. If the icon's location is correct, the customer essentially merely submits the map to the provider, which, in the case of Mapquest, results in providing the service provider with the latitude and longitude of the site of the property. If the icon's location is incorrect, the customer may, using a computer mouse or similar device, relocate the property to its correct location on the street map. In either event, the provider electronically receives the latitude and longitude of the site of the property correctly identified.

Back at the service provider's facility, the latitude and longitude of the property is matched to a list of possible georeferenced FEMA flood maps and the maps on the list are returned to the customer. The customer then selects from the maps one or more maps that apply to the property. At times, the site of the property may be included on two or more FEMA maps. In this event, if a flood hazard determination has been requested by the customer, the service provider typically intervenes and determines which single FEMA map containing the property will besent to the customer. On the other hand, if a FIRM, a summary FIRM or a Floodscape m has been requested by the customer, the service provider may furnish the multiple to the customer. This is effected by clicking on icons identifying the relevant maps.

The customer may save the flood map containing the delineated site of the property in digital form on a hard disk or other memory of the computer system, on a floppy disk, on a CD or on hard copy produced by a printer by clicking on the proper icon.

### EXAMPLE 2

This is similar to Example 1, except that instead of being invited to provide an address, the customer is electronically presented on a computer system with a display of a georeferenced street map. The customer is asked to identify the location of the property on the street map by appropriately clicking a mouse or a functionally similar device. Once the property's site has been so marked, the customer electronically transmits the marked map to the service provider, and the remainder of the method may proceed as described above.

### EXAMPLE 3

As in Examples 1 and 2, the customer ultimately receives a flood map, or a map presenting some other geographic or ecological, or climatological characteristic of and at the property and its environs with the site of the property indicated. The location of the property need not necessarily be a “point” on the displayed map image. The site of the property may also constitute an area surrounded by a polygonal boundary. The polygon may be electronically drawn by the customer by virtue of the service provider having electronically furnished annotation tools along with the street map.

### EXAMPLE 4

As in Examples 1, 2 and 3, however instead of receiving an entire FEMA flood map, the customer electronically receives only the relevant portion of a flood map—for example, a FIRM or a Flood Hazard Boundary Map (“FHBM”). A FIRM and a FHBM are both types of “flood maps.” A flood map that indicates the property site thereon is called a “Floodscape™.” a portion of the proper FEMA flood map with the property's site indicated thereon. The property site may be more or less centrally located on the map portion. The scale of the map provided to the customer may be selectively different—either smaller or larger—than the scale of the paper FEMA map from which the raster map was made and may be selected to permit the customer to print the map on paper of a common size, e.g., ½″ by 11″ or A4. The map portion provided to the customer may also be rotated by the service provider from its orientation on the original FEMA paper map, which may be desirable where the original FEMA map did not have North directed “upwardly.”

If the site of the property is close to a boundary of the FEMA flood map, it may be desirable to “stitch” or add portions of adjacent flood maps so the site is totally surrounded by a flood map display and not partially by “empty” space. Because the flood map containing the site of the property is georeferenced, so too are its boundaries and points on the boundaries. These boundaries are, of course, also the boundaries of adjacent flood maps, in the case of abutting flood maps, and include the common corner points of flood maps the corners of which touch or are common.

Other information may be added to or may accompany the FEMA map. Property markers and boundary lines and other information not present on the original FEMA paper map may be added to the map, as may a compass direction marker or compass rose and a scale legend. Other information may accompany the electronically furnished FEMA map in margins provided around the map by selection of an appropriate scale therefor. Such information may include a variety of textual material, whether or not it is provided on the original paper flood map or its raster image. This textual material may include such information as the flood map panel number or suffix, community names, map revision dates, the name and address of the service provider, and/or the name of an entity that issues flood insurance.

### EXAMPLE 5

This Example is similar to any of Examples 1-4, but early contact between the customer and the service provider includes the service provider agreeing to furnish the customer with a memory medium (diskette, CD-ROM), firmware, or a device from which the customer can download and display on a computer display either the georeferenced street map or the address form of earlier examples. In either event, the medium or device also may include appropriate tools for annotating or completing the street map and/or form and transmitting them to the service provider, who thereafter furnishes the requested flood maps and/or relevant insurance quotations, mortgage quotations, an updated map (where the previous version has been changed).

### EXAMPLE 6

In this Example, the service provider places the customer in the position of providing maps and/or some or all of the products mentioned above showing the sites of properties of interest along with certain geographic, climatological, ecological, demographic or other characteristics or traits, such as the flood zone status of the sites and the surrounding areas, the quality of the air at and around the properties' sites, the likelihood of an earthquake occurring at or near a property's site, and other such information. Here the service provider furnishes the customer with the software/hardware necessary to cause a general-purpose computer to perform all of the methods described herein. The software may be resident on a storage media, such as a disk, diskette or CD-ROM, or it may be resident on a server or the like. Indeed, the latter manner of furnishing the software is especially expedient where the customer intends to provide maps depicting property and geographic conditions over a large area, such as is the case with the 100,000+ FEMA maps covering the entire US.

### EXAMPLE 7

Here, the service provider utilizes information concerning mortgages, houses for sale, recent contracts of real estate sale where closings has not yet occurred, etc., to develop a database of property owners who might have an interest in learning about flood zones and/or flood zone insurance. Having retrieved the address of each property in question, the service provider develops a flood zone map indicating the location of each property. On each flood zone map or adjacent thereto, for example in a margin or border surrounding the map as displayed or printed, the service provider appends additional information such as an indication of how far the property is from a flood zone, premium ranges for an appropriate level of flood insurance, or other marketing/sales information relating to a product or service tied to flood zones, applicable statutes and/or insurance.

### EXAMPLE 8

In this Example, denoted a “flood zone alert plan” (or “FloodZAP”), the service provider and the customer enter into an agreement pursuant to which the service provider agrees to send the customer updated maps when such are required. In the case of FEMA flood maps, this would occur if and when FEMA amends or changes a flood map for any reason, including, without limitation, conducting a more contemporaneous or thorough flood survey, whether or not flood characteristics have changed, or altered geographic or other conditions that have changed flood characteristics. These changes are effected by various types of change notices, known as, FEMA flood insurance rate maps (“FIRM”), Letters of Map Amendment (“LOMA”), Letters of Map Revision (“LOMR”), and/or Letters of Map Change(“LOMC”). If, after the service provider has previously identified the property of interest and furnished one or more products, a change notice is issued, and the changes materially affects the property or matters relating thereto, a new version of the relevant product(s) is then sent to the customer, electronically or on a memory medium/device, as described in earlier Examples. In addition to the revised product, the service provider may furnish the customer with a letter informing of the effects of the change and desirable action(s) that may be taken to conform to, or ameliorate the effects of, the change.

For example, a property that was not previously located in a special flood hazard area (“SFHA”) may now be located therein. If so, and if the community containing the property participates in the National Flood Insurance Program (“NFIP”), it may be necessary for the customer to acquire, or for some entity, such as the lender or loan servicer, to acquire, flood insurance on behalf of the customer. The name and address of one or more flood insurance providers may be provided, as may premium rate schedules. Similarly, if a property is “moved out” of an SFHA, the need for flood insurance may be decreased or eliminated.

The foregoing is important when the customer is a homeowner. In general, the NFIR Act of 1994 requires federally regulated lenders (all national banks, all federal credit unions, and all mortgage companies that sell to Fannie Mae/Ginnie/Mae) to perform a flood hazard determination each time they “make, extend, renew, or increase” a loan on real property that is secured by a structure or mobile home having a value in excess of $1,000.00. The purpose of the Act is to ensure that lenders determine whether any improvements are located in an SFHA. In addition, the lender must track property during the “term of the loan” to ascertain whether there are any changes in the flood zone status of such improvements after the date of any of the foregoing trigger events.

If the property's flood zone status changes so that mortgaged improvements are now located in an SFHA, the relevant lenders/mortgagees must require the mortgagor to purchase flood insurance. If the mortgagor refuses, or otherwise does not, do so, then the mortgagee(s) must “force place” flood insurance for the mortgagor. However, if the change results in the property no longer being in an SFHA, the mortgagee usually does not, or is unlikely to, alert the mortgagor that flood insurance is no longer needed. Pursuant to this embodiment, the homeowner can take advantage of lowered or eliminated need for flood insurance.

While the invention has been described and exemplified with reference to various embodiments, it will be understood by those skilled in the art that various changes in form and detail may be made herein without departing from the spirit and scope of the invention as set forth in the following claims.

What is claimed is:

1. A computer-implemented method by which a service provider furnishes to a customer a summary map which depicts a selected trait at the site of, and in the vicinity of, a selected property, which method comprises:
(a) electronically obtaining from the customer the location of the site of the property;
(b) thereafter, electronically locating the site of the property on a georeferenced digital map that depicts the selected trait and is one of a continuum of other georeferenced maps, all of the georeferenced maps depicting the selected trait;
(c) electronically delineating the site of the property on the georeferenced map; and
(d) electronically storing and transmitting to the customer a selected portion of the georeferenced map as a summary map of the vicinity of the site of the property, with the site delineated on that portion.

2. A method as in claim 1, wherein:
before the summary map is stored and transmitted to the customer, one or more of the following is effected:
(i) changing the scale of the summary map from that of the georeferenced map,
(ii) appending to the summary map a scale legend,
(iii) rotating the summary map out of the orientation of the georeferenced map to present North in a selected orientation,
(iv) appending a compass rose to the summary map,
(v) appending property markers and/or boundary lines not shown on the georeferenced map to the summary map, or
(vi) adding other map annotations provided or requested by the customer.

3. A method as in claim 1, wherein:
following step (c), if the site is near a boundary or corner of the georeferenced map,
producing a surrogate georeferenced map made up of a portion of the georeferenced map and portions of those other georeferenced maps of the continuum which (i) have a boundary or corner in common with the boundary or corner of the georeferenced map and (ii) are proximate the delineated site, the surrogate georeferenced map being thereafter affected by step (d).

4. A method as in claim 3, wherein:
the site is electronically generally centrally located on the surrogate second map that is stored and transmitted to the customer.

5. A method as in claim 4, wherein:
the selected trait is the flood zone classification of the site and of the area in the vicinity thereof.

6. A method as in claim 5, wherein:
before the surrogate map is stored and transmitted to the customer, selected information on the georeferenced map, is appended thereto.

7. A method as in claim 6, wherein:
the selected information comprises panel designation, panel suffix, panel effective date, community name, or county name.

8. The stored and transmitted summary map produced by the method of claim 1.

9. The stored and transmitted summary map produced by the method of claim 2.

10. The stored and transmitted summary map produced by the method of claim 3.

11. The stored and transmitted summary map produced by the method of claim 4.

12. The stored and transmitted summary map produced by the method of claim 5.

13. The stored and transmitted summary map produced by the method of claim 6.

14. The stored and transmitted summary map produced by the method of claim 7.

15. A method as in claim 1, wherein:
the site is electronically generally centrally located on the surrogate second map that is stored and transmitted to the customer.

16. A method as in claim 15, wherein:
the selected trait is the flood zone classification of the site and of the area in the vicinity thereof.

17. A method as in claim 16, wherein:
before the surrogate map is stored and transmitted to the customer, selected information on the georeferenced map, is appended thereto.

18. A method as in claim 17, wherein:
the selected information comprises panel designation, panel suffix, panel effective date, community name, or county name.

19. The stored and transmitted summary map produced by the method of claim 15.

20. The stored and transmitted summary map produced by the method of claim 16.

21. The stored and transmitted summary map produced by the method of claim 17.

22. The stored and transmitted summary map produced by the method of claim 18.

23. A computer-implemented method by which a service provider furnishes to a customer a map which depicts a selected trait at the site of, and in the vicinity of, selected property, which comprises:
electronically furnishing the customer with facilities and instructions for the use thereof so that the customer can electronically enable the service provider to electronically locate the site of the property on a georeferenced map that depicts the selected trait;
thereafter, electronically locating and delineating the indicated site on the georeferenced map, the georeferenced map being one of a continuum of georeferenced maps all of which depict the selected trait over a large geographic area; and
electronically storing and providing to the customer a selected portion of the georeferenced map with the site delineated thereon, the map portion being accompanied by other selected information.

24. A method as in claim 23, wherein:
following the locating and delineating step, if the site is near a boundary or corner of the georeferenced map, the method further comprises
producing a surrogate georeferenced map made up of a portion of the georeferenced map and portions of those other georeferenced maps of the continuum which (i) have a boundary or corner in common with the boundary or corner of the georeferenced map and (ii) are proximate the delineated site, the surrogate georeferenced map being stored and transmitted to the customer.

25. A method as in claim 24, wherein:
the selected trait is the flood zone classification of the site and of the area in the vicinity thereof, the georeferenced map and the other georeferenced maps in the continuum and the surrogate map being digital versions of FEMA paper flood maps, and the stored and transmitted surrogate map includes selected information found on or relating to the paper map version of the georeferenced paper map.

26. A method as in claim 25, wherein:
the site is electronically generally centrally located on the surrogate map that is stored and transmitted to the customer.

27. The stored and transmitted map produced by the method of claim 23.

28. The stored and transmitted surrogate map produced by the method of claim 24.

29. The stored and transmitted surrogate map produced by the method of claim 25.

30. The stored and transmitted surrogate map produced by the method of claim 26.

31. A method as in claim 25, wherein:
before the georeferenced map or the surrogate map, as the case may be, is stored and transmitted to the customer, one or more of the following is effected:
(i) changing the scale from that of the original map and its resulting georeferenced map,
(ii) appending a scale legend,
(iii) rotating the map out of the orientation of the original map and the georeferenced map to present North in a selected orientation,
(iv) appending a compass rose,
(v) appending property markers and boundary lines not shown on the paper map or the georeferenced map,
(vi) adding other map annotations provided or requested by the customer,or
(vii) if the stored and transmitted summary map is the surrogate map, appending selected information from the georeferenced map to the summary map.

32. The stored and transmitted map produced by the method of claim 31.

33. A method as in claim 23, wherein:
the selected trait is the flood zone classification of the site and of the area in the vicinity thereof, the georeferenced map being a digital version of a FEMA paper flood map, and
the stored and transmitted summary map includes selected information found on or relating to the paper map version of the georeferenced paper map.

34. A method as in claim 33, wherein:
the site is electronically generally centrally located on the summary map that is stored and transmitted to the customer.

35. The stored and transmitted map produced by the method of claim 33.

36. The stored and transmitted map produced by the method of claim 34.
